(19) United States
(12) Patent Application Publication
(10) Pub. No.: US 2009/0260749 A1
(43) Pub. Date: Oct. 22, 2009

(54) FACE PAINTING APPARATUS AND METHOD

(76) Inventor: Gabriel Ankamafio-Adjei, Rochester, NY (US)

Correspondence Address: David Henn, Attorney, 2604 Elmwood Avenue, Suite 277, Rochester, NY, 14618, US

(21) Appl. No.: 12/412,337

(22) Filed: Mar. 26, 2009

Related U.S. Application Data
(60) Provisional application No. 61/039,791, filed on Mar. 26, 2008.

(51) Int. Cl. B44C 1/165; B32B 37/00

(52) U.S. Cl. 156/230; 156/349

(57) ABSTRACT

By using a sheet of material, such as a film or paper sheet, as the base for body paint formed into indicia, such as designs, logos, characters, pictures, and/or text, an easy body paint application apparatus and method are produced. The inventive easy body paint apparatus and method overcomes design issues to provide an easy and portable way of body painting for consumers.

### CROSS-REFERENCE TO RELATED APPLICATIONS

This application claims the benefit of the filing date of U.S. Provisional Patent Application No. 61/039,791, filed 26 Mar. 2008.

### BACKGROUND AND SUMMARY

Body painting, particularly face painting, has largely been in its current form since its inception, but with growing popularity among people each year, there is a corresponding increase in demand. Typically, artists work professionally as body painters around the globe to depict characters and logos on the faces or other body parts of customers using temporary inks or paints or dyes, but this is very time consuming and can be expensive. Alternatively, consumers can purchase makeup, either in kits or separate components, and apply the makeup themselves. Even in the case of kits, the application of the makeup or body/face paint can be quite time consuming and will often produce undesirable results due to the inexperience of the consumer in applying makeup or body/face paint. Thus, there is a need for easier, less expensive body/face painting.

Embodiments of the invention disclosed herein provide easily applied, pre-printed body paint. The body paint is printed on a flexible film, such as silicone, plastic, rubber, latex, or the like, or another material coated with silicone, plastic, rubber, latex, or the like. In an embodiment, a corresponding sheet acts as a release liner and can include the characters, logos, etc., depicted with the body paint surface. The consumer removes the release liner, aligns the body paint with his or her body part of choice, and applies the body paint by pressing the flexible film onto his or her skin. Embodiments include guide markings or cutouts to ease alignment of the paint design. In an embodiment, a clear matte liquid is placed between the flexible film and the paint to enhance release of the paint and to protect the paint once it is applied to the user's skin. Additionally, an embodiment uses a paper or paper-backed liner on the side of the flexible film opposite the paint or clear matte liquid to protect the film and the paint. An adhesive is applied to the skin side of the body paint in embodiments to enhance transfer and adherence to the skin of the user by the body paint. This will replace the hassle consumers face to get to a body painter whenever they want or need to apply body paint, will be more convenient, will cost less, and will consume far less time. The uses for embodiments can even include professional environments, such as the production of movies, television programs and commercials, modeling, and other situations in which makeup artists might be employed.

### BRIEF DESCRIPTION OF THE DRAWINGS

Embodiments will be described with reference to the accompanying drawings.

FIG. 1 is a schematic view of the flexible film and release liner with indicia on the release liner.

FIG. 2 is a schematic illustration of the face of a consumer to which body paint or makeup can be applied with embodiments.

FIG. 3 is a schematic illustration of the face of a consumer with a body painting apparatus according to embodiments pressed on his or her face.

FIG. 4 is a schematic illustration of a consumer in the process of releasing and peeling away the flexible film according to embodiments.

FIG. 5 is a schematic illustration of a body painting apparatus according to embodiments disclosed herein.

FIG. 6 is a schematic illustration of a body painting apparatus according to embodiments disclosed herein applied to a thigh of a user.

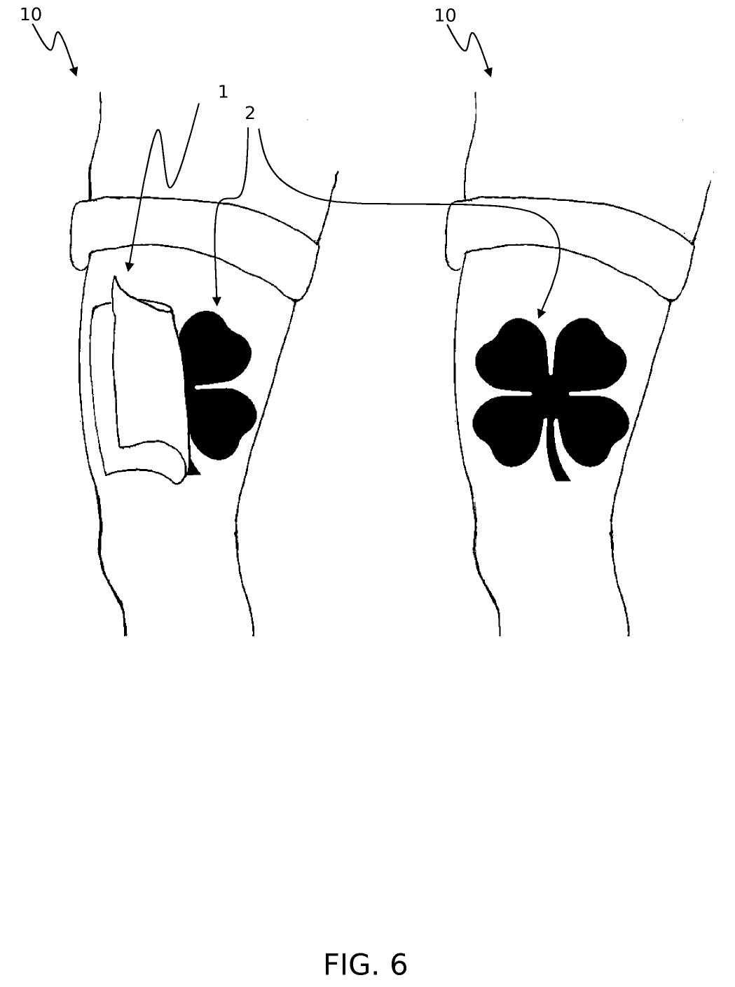

FIG. 7 is a schematic illustration of a body painting apparatus according to embodiments disclosed herein applied to a shoulder of a user.

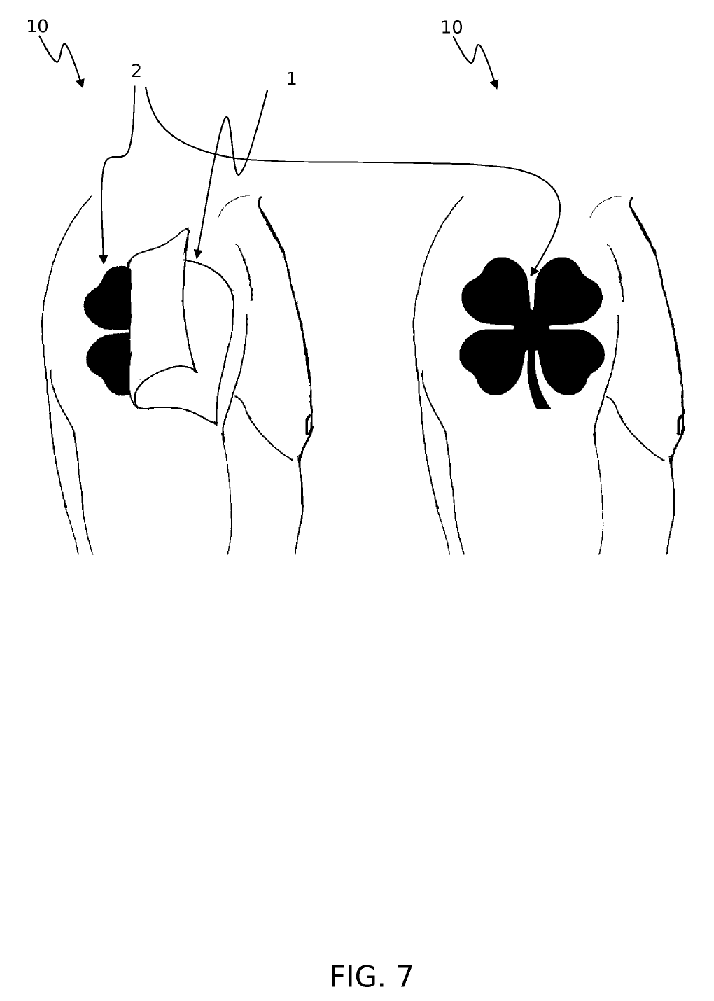

FIG. 8 is a schematic illustration of a body painting apparatus according to embodiments disclosed herein applied to a back of a user.

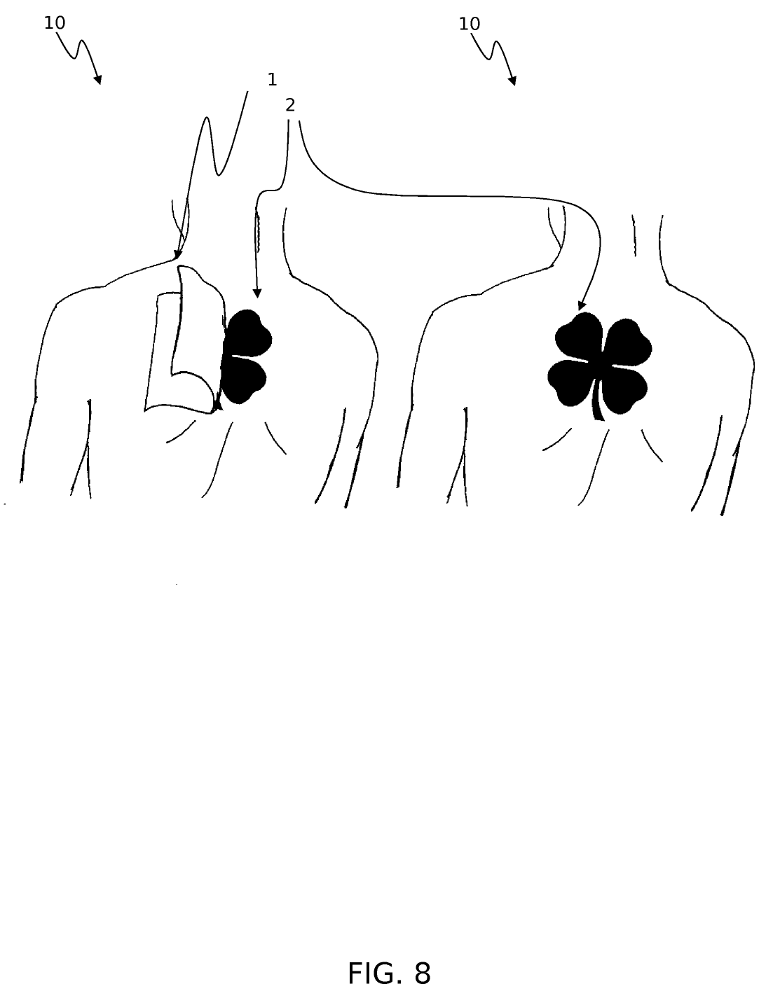

### DESCRIPTION

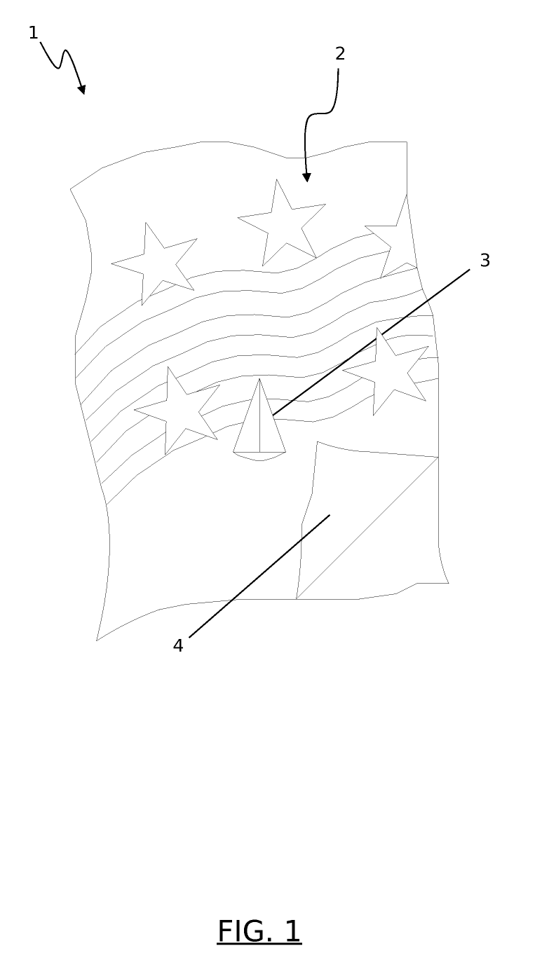

Referring to the accompanying FIG. 1, a flexible film 1 has a first surface that bears body paint 2 in the mirror image of a predetermined desired pattern and a second, opposite surface that is free of face or body paint.

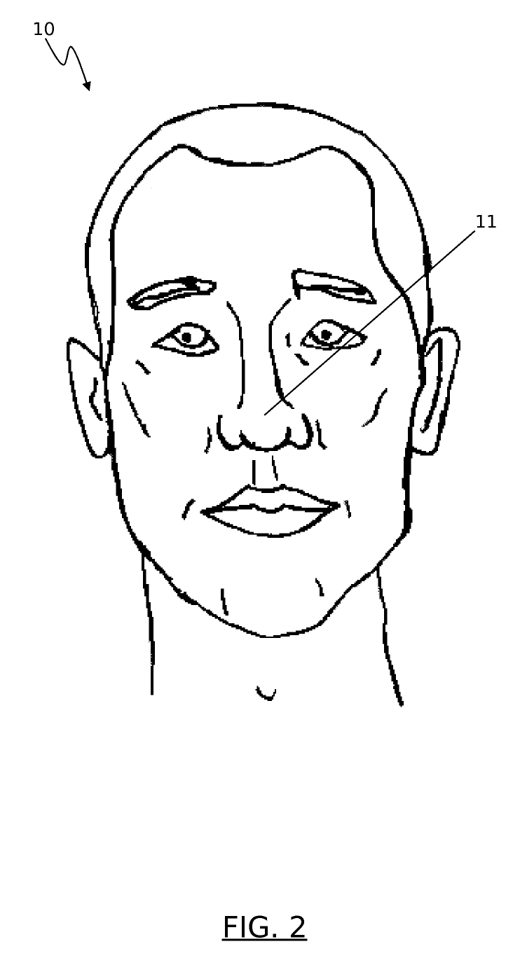

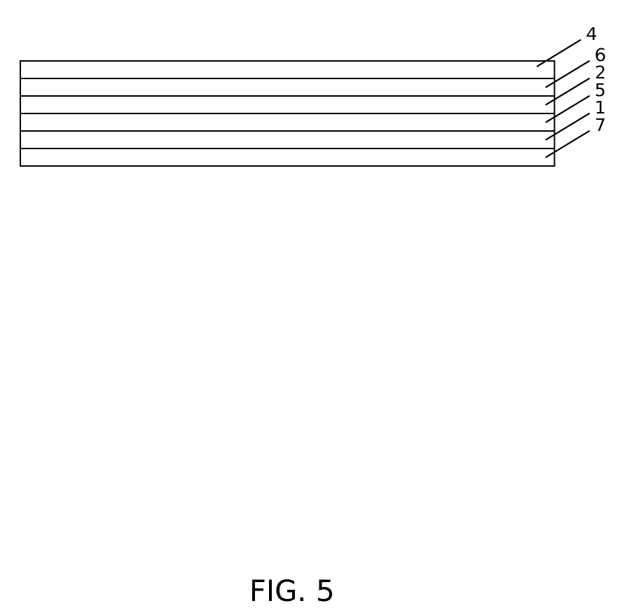

As used herein, “body paint” refers to make-up, ink, dye, or other materials that provide color and can be applied to the skin of a user. In particular, FDA approved materials are used in embodiments. Further, in embodiments, “body paint” can refer to medications that are delivered to or via the skin of a user 10. The flexible film can be made from silicone, plastic, paper, rubber, or any other suitable material, or can be made from a flexible material and coated with silicone, plastic, paper, rubber, or any other suitable material. Preferably, the flexible film 1 includes guide indicia 3 that provide a reference point for the user in the application of the body paint 2 to the skin of a user 10 as seen in FIGS. 2-4. Additionally, as seen in FIG. 5, a second layer of material 4 is preferably included so that the body paint 2 is between the flexible film 1 and the second layer of material 4.

The second layer of material 4 acts as a release liner, and protects the body paint 2 from damage, such as smearing or drying out, until the user is ready to use it. The film 1, body paint 2, and guide indicia 3 can be sized to take the age of an intended user and/or the body part on which the design is intended to be used into account.

Thus, several versions of a given pattern can be offered in different sizes for different age groups and/or different body parts. To enhance transfer of the body paint 2 from the film 1 to the face of the user 10, an easy release coating 5, such as a clear matte liquid, can be included on or applied to the film 1 and/or an adhesive 6 can be applied to the skin-side of the body paint 2. An additional layer of material 7, such as a liner or paper-backed liner, is included on the side of the flexible film 1 opposite the side on or over which body paint 2 is applied in embodiments to further protect the film 1 and paint 2, such as when the assembled product is rolled for packaging. Thus, an embodiment has a liner 7, a flexible film 1, a clear matte liquid 5, body paint 2, an adhesive 6, and a second layer of material 4 that acts as a release liner, and keeps the body paint from drying out.

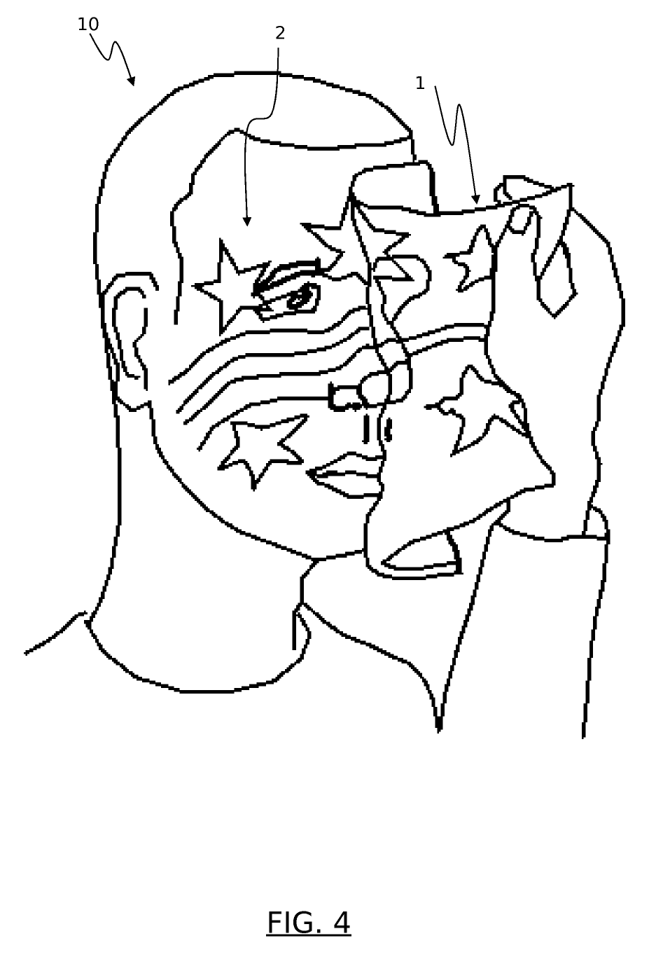

The guide indicia 3 can take many forms. In the exemplary embodiment shown in FIGS. 2-4, in which a face painting embodiment is depicted, the guide indicia 3 include a triangle to be arranged over the nose 11 of a user. In embodiments, breathing holes can be included if deemed necessary, though the invention can work quite well without such breathing holes since the amount of time through which the flexible film 1 will cover the face of the user 10 is suitably short. In embodiments applied to parts other than the face or to parts of the face that do not include the nostrils, the breathing holes can be eliminated regardless of duration of application time. At the point where the user is ready to use the body paint 2, the user peels away the release liner 4 and uses the guide indicia 3 to orient the face paint 2 on the flexible film 1 with the first surface and face paint 2 facing the face of the user 10. When the guide indicia 3 are in the proper place, the user presses the flexible film 1 against the face of the user 10, rubbing if necessary to transfer the paint 2 from the flexible film 1 to the skin of the user 10. Once the paint 2 adheres to the skin of the user 10, the user can peel the flexible film 1 away from the skin, leaving the paint 2 behind, as seen in FIG. 4.

To recap, a flexible film, such as a rubber or plastic film or paper sheet, can be used as a base that the body paint will be printed on. The body paint is what will come into contact with the skin of the consumer. A first surface of the flexible film will be the side carrying body paint in the form of a design, logo, and/or character, and the second side will show nothing other than that it will be the side a consumer will use his/her palm to press on to make the body paint stick to the skin.

Guide indicia can include a thin line dotted line that can guide a consumer as the starting point to apply the body paint on the intended body part. In the case of embodiments applied to the face and including the nose, the consumer's nose is preferably the first contact point and the thin dotted lines will be applied right to the tip of the nose to enable a better transfer and better alignment of the body paint. At the base of the thin dotted triangle can be a cut, which can vary in length according to consumer age, for example, to help breathing while applying the body paint film or sheet to the face.

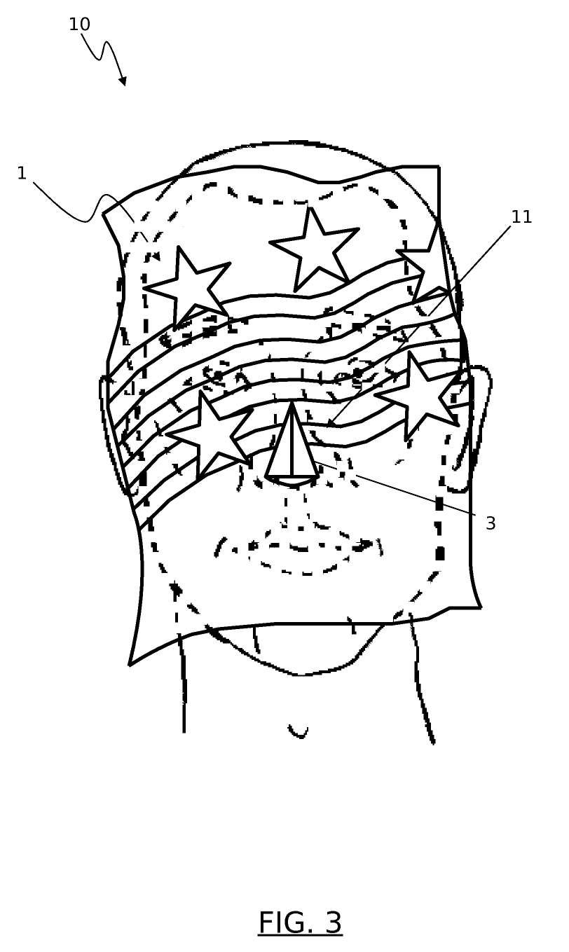

Referring to FIGS. 3-4, the rubber film/paper sheet side with the body paint, such as face paint in the form of a logo/character, will be the side attached and pressed to face with the first point of contact to face being the thin dotted triangular shape placed at the tip of the nose to have a satisfactory result. FIG. 4 will be the final step to having successfully applied the face paint by peeling away the rubber film/paper sheet away from face leaving the temporal paint on face with a logo or character. A method of body painting can include forming with body paint a desired pattern and/or design, such as logos or characters, in a reverse form on a film, which can provide for the consumer minimal work to apply the pattern to the skin. The side of the film which is to used for the body paint might carry a coated surface or coating layer, such as a clear matte liquid, to ease the transfer of the body paint to the consumer's skin. The method can include providing a cut in the middle of the film of face painting embodiments to aid breathing while the body paint is being applied to the face/skin. The cut can be made according to consumer ages. Providing a thin dotted triangle shape in the middle of the face paint can serve as the starting point of application to the consumer. The dotted lines preferably do not show on the other side (the outside view) of the logo or character. It will only show on the side where the face paint will come into contact with the consumers face. Providing the dotted triangular lines according to consumer's age to be used as the starting point of applying the face paint onto the consumers skin.

For both coated and non-coated films the desired pattern can first be painted with a clear matte, such as a clear matte liquid, to enhance the release of the body paint or temporary ink from the film/paper to the skin of the user.

It will be appreciated that various of the above-disclosed and other features and functions, or alternatives thereof, may be desirably combined into many other different systems or applications. In particular, while the embodiments shown in the FIGS. are face-oriented, it should be understood that embodiments can be used with any body part such as, but not limited to, the chest, the back, the stomach, the arms, the hands, the legs, and the feet. It will also be noted that various presently unforeseen or unanticipated alternatives, modifications, variations or improvements therein may be subsequently made by those skilled in the art which are intended to encompassed by the following claims.

What is claimed is:

1. A body painting method comprising:
providing body paint;
providing a flexible film;
placing the body paint on the flexible film in a mirror image of a desired pattern;
orienting the flexible film over a body part of a user;
pressing the flexible film against the body part of the user to transfer the body paint to skin of the user on the body part; and
removing the flexible film.

2. The method of claim 1 further comprising placing a release liner against the body paint so that the body paint sits between the flexible film and the release liner.

3. The method of claim 1 further comprising providing guide indicia on the flexible film and orienting the flexible film includes employing the guide indicia.

4. The method of claim 3 wherein providing guide indicia comprises providing guide indicia to be situated over a nose of the user.

5. The method of claim 4 wherein providing guide indicia further comprises forming a triangle on a body paint side of the flexible film.

6. The method of claim 3 wherein providing guide indicia includes sizing the guide indicia according to an age of an intended user.

7. The method of claim 1 further comprising providing at least one breathing hole in the flexible film.

8. The method of claim 1 further comprising placing an easy release coating on the flexible film to enhance transfer of the body paint to the skin of the user.

9. A body painting apparatus comprising:
a flexible film;
body paint applied to the flexible film in a mirror image of a desired pattern; and
a release liner applied to the body paint so that the body paint sits between the release liner and the flexible film.

10. The apparatus of claim 9 further comprising guide indicia.

11. The apparatus of claim 10 wherein the guide indicia comprise markings arranged to be situated over a nose of a user.

12. The apparatus of claim 11 wherein the markings comprise a triangle.

13. The apparatus of claim 10 wherein the guide indicia are sized according to an age of an intended user.

14. The apparatus of claim 9 further comprising an easy release coating on the flexible film.

15. The apparatus of claim 9 further comprising an adhesive applied to the skin side of the body paint.
